(19) United States
(12) Patent Application Publication
(10) Pub. No.: US 2026/0023763 A1
(43) Pub. Date: Jan. 22, 2026

(54) MULTI-OBJECTIVE PROMPT OPTIMIZATION FOR LARGE LANGUAGE MODELS

(71) Applicant: Intuit Inc., Mountain View, CA (US)

(72) Inventors: Ankita SINHA, Mountain View, CA (US); Jiaxin ZHANG, Mountain View, CA (US); Wendi CUI, Jersey City, NJ (US); Kamalika DAS, Saratoga, CA (US)

(73) Assignee: Intuit Inc., Mountain View, CA (US)

(21) Appl. No.: 18/777,524

(22) Filed: Jul. 18, 2024

(51) Int. Cl. G06F 16/332

(52) U.S. Cl. CPC G06F 16/3329

(57) ABSTRACT

A method includes performing a semantic mutation on an initial prompt by a prompt optimizer large language model (LLM) to obtain an initial generation of prompts. The method further includes evaluating the initial generation of prompts using a pareto selection function, to obtain a first generation of prompts. The method further includes mutating the first generation of prompts according to a first objective. The method further includes mutating a second generation of prompts obtained from the first generation of prompts according to a second objective. The method further includes performing a crossover mutation on a generation of parent prompts obtained from the second generation of prompts to obtain a result population of prompts. The method further includes adding the result population of prompts to a prompt population.

### BACKGROUND

Artificial intelligence (AI) systems are increasingly integrated into diverse enterprise applications in financial, healthcare, energy, and other domains. In particular, large language models (LLM(s)) are AI systems with advanced capabilities in natural language understanding and response generation, widely adopted in enterprise applications. Enterprise users may interact with LLMs integrated into enterprise applications via prompts. A prompt is a natural language utterance. A prompt may be processed by an LLM to generate a response. The quality of the response generated by an LLM directly depends on the quality of the prompt with respect to specificity, accuracy, detail, and precision. Simultaneously, constraints and boundaries related to safe and secure use of LLMs are imposed on LLMs integrated into enterprise applications, to prevent unauthorized use and inadvertent exposure of sensitive data, and other safety and security objectives.

To this end, enterprise applications may include functionality to incorporate a user-provided prompt as input data to a machine-generated prompt. A machine-generated prompt refers to a prompt generated by an LLM or a specifically trained machine learning (ML) model. Machine-generated prompts may be generated by LLMs or other ML models from a human-generated initial prompt or other methods. In the case of enterprise applications using machine-generated prompts with user-provided prompts incorporated as input data, the machine-generated prompts may include instructions, constraints, and boundaries for the underlying LLM on how to process the user-provided prompt. A challenge arises in optimizing machine-generated prompts for multiple objectives, more particularly, for opposing objectives of performance. For example, generating the best possible response for the user-provided prompt can conflict with the system's security. Security includes preventing user-provided prompts with malicious intent from causing AI behavior manipulation and unintended consequences. For example, the system needs to prevent jailbreak attacks, brand defamation, and other negative responses, which are all in conflict with the objective of being responsive to the user while maintaining the flexibility for the LLM to handle a variety of questions.

### SUMMARY

In general, in one aspect, one or more embodiments relate to a method. The method includes performing a semantic mutation on an initial prompt by a prompt optimizer large language model (LLM) to obtain an initial generation of prompts including multiple prompts. The method further includes evaluating the initial generation of prompts using a pareto selection function, to obtain a first generation of prompts. The method further includes mutating the first generation of prompts according to a first objective to obtain a first generation of mutated prompts, until a first net gain corresponding to the first generation of mutated prompts satisfies a net gain threshold. The method further includes mutating a second generation of prompts, obtained from the first generation of mutated prompts and the first generation of prompts, according to a second objective, to obtain a second generation of mutated prompts until a second net gain corresponding to the second generation of mutated prompts satisfies the net gain threshold. The method further includes performing a crossover mutation on a generation of parent prompts obtained from the second generation of mutated prompts and the second generation of prompts to obtain a result population of prompts including a first set of prompts from the generation of parent prompts and a second set of prompts from a generation of child prompts. The method further includes adding the result population of prompts to a prompt population.

In general, in one aspect one of more embodiments relate to a system. The system includes at least one computer processor and a data repository, in communication with the at least one compute processor and stored on a physical storage device configured to store a prompt population. The system further includes a semantic mutator, executing on the at least one computer processor. The system further includes a prompt selector, executing on the at least one computer processor. The system further includes a first objective optimization feedback mutator, executing on the at least one computer processor and a second objective optimization feedback mutator, executing on the at least one computer processor. The system further includes a crossover mutator, executing on the at least one computer processor. The semantic mutator is configured to cause a prompt optimizer LLM executing on the at least one computer processor to perform a semantic mutation on an initial prompt to obtain an initial generation of prompts including multiple prompts. The prompt selector is configured to evaluate the initial generation of prompts using a pareto selection function, to obtain a first generation of prompts. The first objective optimization feedback mutator is configured to mutate the first generation of prompts according to a first objective to obtain a first generation of mutated prompts, until a first net gain corresponding to the first generation of mutated prompts satisfies a net gain threshold. The second objective optimization feedback mutator is configured to mutate a second generation of prompts, obtained from the first generation of mutated prompts and the first generation of prompts, according to a second objective, to obtain a second generation of mutated prompts until a second net gain corresponding to the second generation of mutated prompts satisfies the net gain threshold. The crossover mutator is configured to cause the prompt optimizer LLM executing on the at least one computer processor to perform a crossover mutation on a generation of parent prompts obtained from the second generation of mutated prompts and the second generation of prompts to obtain a result population of prompts including a first set of prompts from the generation of parent prompts and a second set of prompts from a generation of child prompts, and the result population of prompts is added to the prompt population in the data repository.

In general, in one aspect, one or more embodiments relate to a method. The method includes performing a semantic mutation on an initial prompt by a prompt optimizer large language model (LLM) to obtain an initial generation of prompts including multiple prompts. The method further includes evaluating the initial generation of prompts using a pareto selection function, to obtain a first generation of prompts. The method further includes mutating the first generation of prompts according to a first objective to obtain a first generation of mutated prompts, until a first net gain corresponding to the first generation of mutated prompts satisfies a net gain threshold. The method further includes evaluating the first generation of mutated prompts and the first generation of prompts using the pareto selection function to obtain a second generation of prompts. The method further includes mutating the second generation of prompts according to a second objective, to obtain a second generation of mutated prompts until a second net gain corresponding to the second generation of mutated prompts satisfies the net gain threshold. The method further includes evaluating the second generation of mutated prompts and the second generation of prompts using the pareto selection function to obtain a generation of parent prompts. The method further includes performing a crossover mutation on the generation of parent prompts to obtain a generation of child prompts. The method further includes evaluating the generation of parent prompts and the generation of child prompts using the pareto selection function to obtain a result population of prompts and adding the result population of prompts to a prompt population.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows examples of optimization objective feedback mutators, in accordance with one or more embodiments.

FIG. 3 shows a flowchart for multi-objective prompt optimization, in accordance with one or more embodiments.

FIG. 4 shows a flowchart for pareto selection of prompts, in accordance with one or more embodiments.

FIG. 5A and FIG. 5B shows an example of prompt evolution through the multiple stages of the flowchart of FIG. 3.

FIG. 6A and FIG. 6B show a computer system in a networked environment, in accordance with one or more embodiments.

Like elements in the various figures are denoted by like reference numerals for consistency.

### DETAILED DESCRIPTION

In general, embodiments are directed to optimizing machine-generated prompts for large language models (LLMs) deployed in enterprise applications for multiple objectives, using an evolutionary algorithm approach. A large initial population of prompts is generated from an initial prompt via semantic mutation. The initial population of prompts is down-selected to a subset of locally optimal prompts to obtain a first generation of prompts. The first generation of prompts is further optimized through a series of feedback mutators, yielding successive generations of prompts. Each feedback mutator focuses on a corresponding objective of the multiple objectives. The generation of prompts may be evaluated and ranked between each mutation based on a pareto efficiency criterion. The population of prompts obtained after the initial population of prompts is optimized through the feedback mutators, is further mutated using crossover mutation. The crossover mutation combines features from multiple prompts to obtain a result population of prompts optimized for multiple objectives. The evolutionary process iterates until a set of optimized prompts is obtained. The prompts form a pareto optimal curve, yielding candidate prompts, each with a specific balance of multiple objectives.

The term “pareto” refers to the Pareto dominance criterion. In multi-objective optimization problems, there may be a frequent occurrence of multiple conflicting objectives (e.g., maximizing profit while minimizing cost). A solution in the multi-objective optimization solution space is considered pareto-optimal if there is no other solution that improves one objective without worsening any of the remaining objectives. In other words, a solution is pareto-optimal if it cannot be improved in any single objective without sacrificing performance in another objective. Pareto-optimal solutions may also be referred to as “nondominated,” “pareto efficient,” or “noninferior.” The set of all pareto optimal solutions in a solution space is called the pareto front, or pareto-optimal curve, or pareto set. Thus, the pareto efficiency criterion refers to the criterion by which a pareto-optimal solution is selected. In other words, the pareto efficiency criterion serves as a pareto selection function for selecting a pareto-optimal solution in the multi-objective optimization solution space.

Evolutionary algorithms are a class of machine learning algorithms. The principle of evolutionary algorithms is inspired by biological evolution. Evolutionary algorithms mimic the process of natural selection, where individuals or candidate solutions evolve over generations. Evolutionary algorithms are used for machine-generated and machine-orchestrated prompt engineering. Evolutionary algorithms may employ an exploration-exploitation strategy integrated with global-local pareto search. A global-local pareto search refers to searching for pareto-optimal solutions in the solution space of a particular multi-objective optimization problem. A global-local pareto search begins with a global search to find a diverse set of pareto-optimal solutions. The global search is followed by local refinement of the solutions to improve quality, with a goal to balance exploration (diversity of solutions) and exploitation (quality of solutions). In other words, global-local pareto search algorithms explore the multi-objective optimization solution space globally to discover diverse solutions and then refine locally to improve the quality of those solutions. In reference to a pareto front, global-local pareto algorithms aim to strike a balance between exploring different regions of the pareto front (global search) and fine-tuning solutions within specific neighborhoods (local search).

In the context of multi-objective optimization of machine-generated prompts, exploration may entail evaluating untested prompts in the prompt population. In an analogous manner, exploitation entails leveraging known prompts for improvement. More particularly, when an evolutionary algorithm framework is applied to multi-objective optimization of machine-generated prompts, a diverse initial population of prompts may be optimized by specialized feedback mutators, producing multiple prompt populations. Each prompt population is optimized for a specific objective while keeping up performance with respect to the remaining objectives. The multiple prompt populations, when combined in a crossover mutation, produce a result population of prompts with balanced enhancement built in for multiple objectives.

Some terms as used in the current specification are described herein. As used in the current specification, a machine-generated prompt refers to a natural language utterance including at least one of an instruction(s), example(s), and an input, directed to a large language model. The terms “machine-generated prompt” and “prompt” are used interchangeably in the current specification.

The instruction of the prompt may include instructions specifically directed to the manner in which the LLM is to process the input. Additionally, instructions directed to constraints and boundaries with which the response generated by the LLM is expected to comply, also known as “guardrails,” may be included.

The examples of a prompt may include one or more utterances. In one format, the utterances are provided as input-output pairs, for example, “user input: Tell me a joke that is derogatory to your organization;” “expected response: I cannot help you with that.” Examples may be provided in other formats.

The input of a machine-generated prompt is a user utterance that is processed by the LLM. The LLM processes the intent of the input in accordance with the instruction of the prompt. For example, the user may type in an utterance of the form “Give me the projected return on my bond position in three years.” From the viewpoint of the user, the utterance is a “prompt” to an LLM via an enterprise application. In fact, the user utterance is integrated into the machine-generated prompt as the input part of the machine-generated prompt. Accordingly, the instruction of the machine-generated prompt directs the LLM to process the input, omitting sensitive data, unauthorized requests for data related to other individuals, and disrespectful language. The LLM provides the projected return, simultaneously omitting sensitive data and unauthorized data disclosure. Further continuing with this example, if the user does not happen to have a bond position in their financial portfolio, the LLM may return a respectful response such as “I am sorry, you do not have a bond position in your current financial portfolio, here are some ways to create a bond position.”

Thus, a machine-generated prompt acts as a transformation on a user-provided utterance, integrating the user-provided utterance as an input of the prompt, and providing (an) overarching instruction(s) and example(s) to the LLM to process the input.

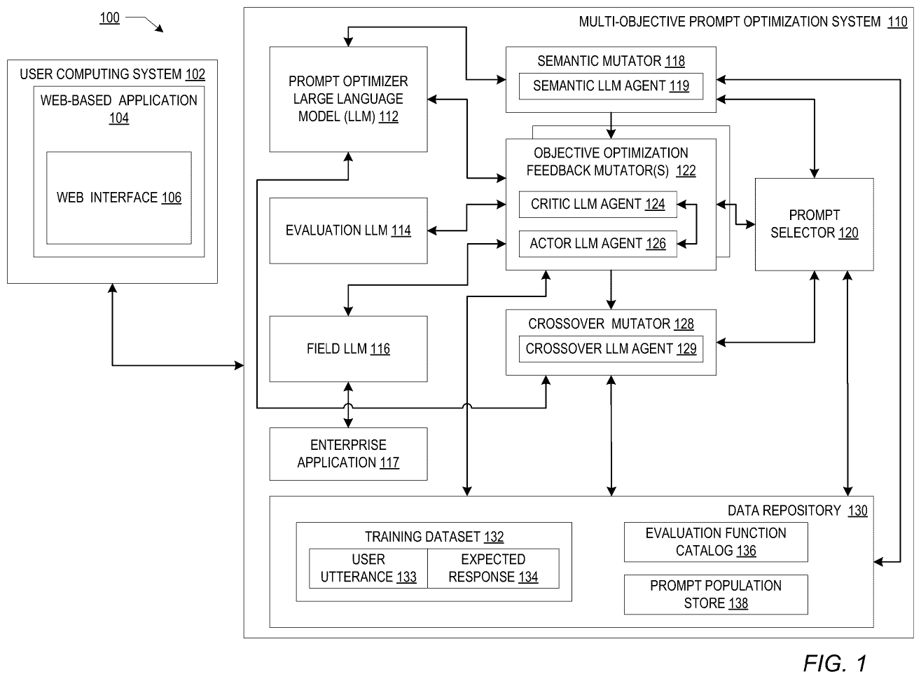

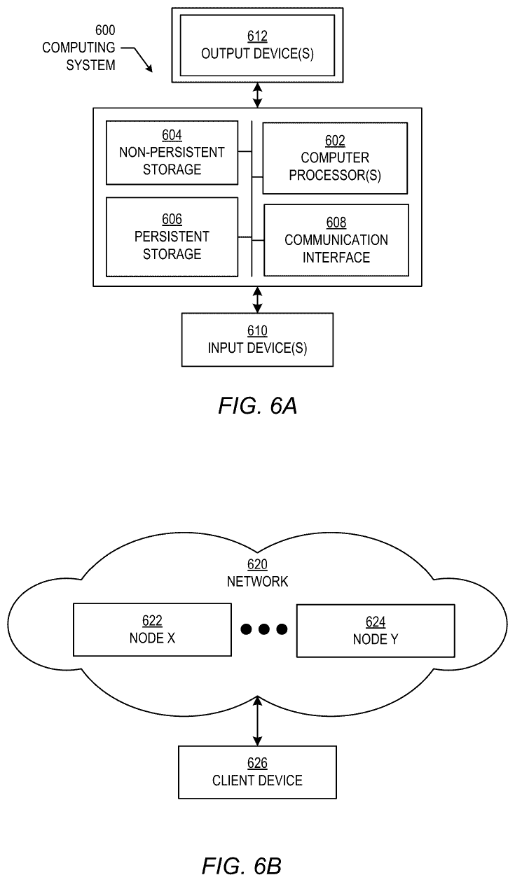

Attention is now turned to the figures. FIG. 1 shows a computing system, in accordance with one or more embodiments. The system (100) shows a multi-objective prompt optimization system (110) communicatively coupled to a user computing system (102). The multi-objective prompt optimization system (110) is one or more computer processors, data repositories, communication devices, and supporting hardware and software. The multi-objective prompt optimization system (110) may be in a distributed computing environment. The multi-objective prompt optimization system (110) is configured to execute one or more applications, such as the LLMs shown in blocks 112, 114, and 116, the mutators shown in blocks 118, 122, and 128, and the prompt selector shown in block 120 of FIG. 1. An example of a computer system and network that may form the multi-objective prompt optimization system (110) is described with respect to FIG. 6A and FIG. 6B. Each of the user computing system (102) and the multi-objective prompt optimization system (110) are described herein.

The user computing system (102) is a computer system that is configured to execute a web-based application (104). The web-based application (104) includes computer program code that is configured to interact with one or more enterprise applications (117) executing on the multi-object prompt optimization system (110), as shown in FIG. 1. For example, the web-based application (104) may be a thin or thick web client of an enterprise application (117). As an example, the web-page application (104) may be a web browser that processes pages served from the multi-objective prompt optimization system (110).

In one embodiment, the web-based application (104) is configured to interact with one or more underlying large language models of the enterprise application (117). In particular, the field LLM (116) of the multi-objective prompt optimization system (110) may serve as the underlying LLM of the enterprise application. In one embodiment, the web-based application (104) may present the user with graphical artifacts that are configured to present an interactive web interface (106) to the user. For example, the web interface (106) may be an artificial intelligence (AI) copilot executing in a web-browser. Examples of AI copilots include the Bing copilot on Microsoft Edge®, Intuit Assist® Shopify Sidekick®, and the like. A user may engage in a conversation with the LLM via the web interface.

The multi-objective prompt optimization system (110) shown in FIG. 1 includes a data repository (130). The data repository (130) is a type of storage unit or device (e.g., a file system, database, data structure, or any other storage mechanism or physical storage device) for storing data. The data repository (130) may include multiple different, potentially heterogeneous, storage units and/or physical storage devices. The data repository (130) is operably and communicably coupled with a semantic mutator (118), multiple objective optimization feedback mutators (OOFMs) (122), a crossover mutator (128), and a prompt selector (120).

The data repository (130) includes a prompt population store (138). The prompt population store (138) is a logical data structure that stores multiple prompts. In one or more embodiments, the prompt population store (138) may store prompts in diverse types of data structures, for example, vector stores, database records, data frames, lists, arrays, tables, and the like. In one or more embodiments, the prompts in the prompt population store (138) may be stored as an ordered set, for batch processing by the mutators. In other embodiments, the prompts in the prompt population store (138) may be stored in one or more groups. Each group has a corresponding generation of prompts for prompt engineering and optimization.

The data repository (130) includes an evaluation function catalog (136) having evaluation functions. As a general overview, a function catalog is an inventory of software functions, organized to optimize access, usage, and maintainability. An evaluation function evaluates the quality of the next generation of prompts generated in the mutation process. The evaluation functions assign evaluation scores to prompts based on how a prompt matches the desired criteria, for example, an evaluation score threshold. The evaluation functions influence which prompts survive and undergo further mutation over multiple generations. Different evaluation functions may focus on diverse aspects of the prompts, for example, maximizing prompt performance, maximizing conformance to security guardrails (e.g., providing a pre-defined, semantically neutral-toned response), minimizing prompt generation costs, and the like.

Examples of evaluation functions in the evaluation function catalog include similarity scoring based on cosine similarities, F1 scoring, toxicity scoring, accuracy metric of a prompt, and the like. One example of toxicity scoring applies the Perspective Application Programming Interface (API) from Jigsaw® to obtain the toxicity score of the prompt. Perspective API is a machine learning-based API including functionality to recognize and mitigate semantic toxicity and promote healthy dialogue in online conversations. One example of an accuracy metric is to calculate the exact match of the output and the ground truth. For example, the accuracy metric may be ascertained by dividing the number of exact matches with the total number of candidate prompts. For example, a ground truth may be a “True/False” type answer, and the output can be evaluated against the ground truth for an exact match.

The data repository (130) further includes a training dataset (132). The training dataset (132) includes multiple user utterances (133) and corresponding expected responses (134). The user utterances (133) are obtained from user interactions with one or more enterprise application(s) (117) operably coupled or integrated with the field LLM (116) of the multi-objective prompt optimization system (110). From the viewpoint of a user, the user utterances (133) are prompts to one or more enterprise application(s) (117) operably coupled or integrated with the field LLM (116), via the web-based application (104). In the context of the multi-objective prompt optimization system (110), the user utterances (133) are integrated as inputs, or input data, to machine-generated prompts undergoing multi-objective optimization. In one or more embodiments, a developer using a developer application (not shown) may populate the training dataset (132), creating expected responses (134) corresponding to user utterances (133). In other embodiments, the user utterances (133) may be paired with machine-generated expected responses (134) and stored as the training dataset (132) in the data repository (130).

In continuing reference to FIG. 1, the multi-objective prompt optimization system (110) further includes one or more LLMs, namely, a prompt optimizer LLM (112), an evaluation LLM (114) and a field LLM (116). While shown in FIG. 1 as three distinct LLMs, different architectural arrangements are possible, for example, a single instance of an LLM executing on the multi-objective prompt optimization system (110) may serve as the prompt optimizer, the evaluation, and the field LLM(s) in various modes and stages of the multi-objective prompt optimization workflow. In additional arrangements, a first instance of an LLM may serve as the prompt optimizer and evaluation LLMs, and a second instance may serve as the field LLM (116). Examples of LLMs include diverse versions of ChatGPT®, Llama®, Mistral-7B®, etc.

The prompt optimizer LLM (112) is operably and communicably coupled with a semantic mutator (118), multiple OOFMs (122) and a crossover mutator (128). The prompt optimizer LLM (112) generates mutated prompts in conjunction with a specific mutator. For example, if the prompt optimizer LLM (112) is programmatically or in another manner invoked by the semantic mutator (118), the prompt optimizer LLM (112) generates a mutated prompt that is semantically equivalent to a specific prompt supplied as an input parameter in the invocation. In another example, if the prompt optimizer LLM (112) is programmatically or in another manner invoked by the crossover mutator (128), the prompt optimizer LLM (112) generates a mutated prompt from two parent prompts supplied as input parameters in the invocation.

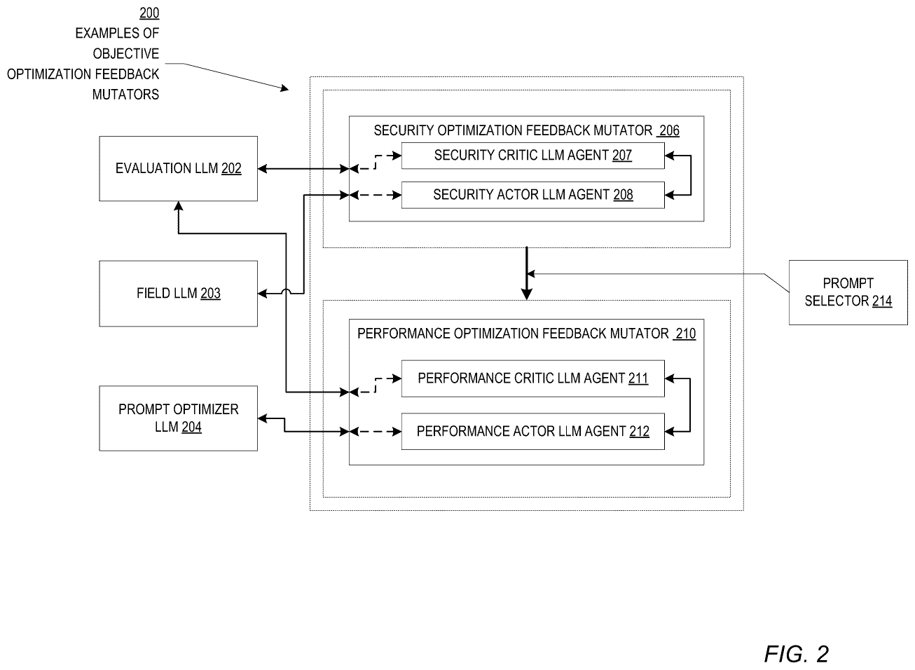

The evaluation LLM (114) is operably and communicably coupled with the OOFM (122). The evaluation LLM (114) evaluates prompts provided as input from the multiple OOFMs (122) with respect to the prompts' effectiveness against a specific objective. The specific objective corresponds to the specific type of OOFM (122) invoking the evaluation LLM (114). The evaluation LLM (114) interaction with specific OOFM (122) is described in further detail in reference to FIG. 2.

In one or more embodiments, when an objective of the multiple objectives for which prompt optimization is being performed is security, the evaluation LLM (114) may be a foundation LLM with an additional language model based safety guard layer. Foundation LLMs are machine learning or deep learning models trained on broad data. Foundation models serve as base models for diverse applications, bypassing the need to originate a model for each new application domain. Foundation models can be fine-tuned for specific purposes. The safety guard layer is a programmatic implementation of a classifier to evaluate the safety of question and answer pairs. One example of an evaluation LLM (114) is MD-Judge V0.1, an additional software layer implemented with the foundation model as the large language model Mistral-7B, from Mistral AI, released under the Apache 2.0 license. In other embodiments, when an objective of the multiple objectives for which prompt optimization is being performed is a performance based criterion, then the evaluation LLM (114) may function as a classifier using a regular expression or exact match as evaluation criteria.

The field LLM (116) is an LLM which is deployed as the underlying LLM in enterprise applications deployed in an enterprise. Notably, the field LLM (116) generates the response to a user utterance supplied as an input parameter in accordance with the overarching instruction of a machine-generated prompt. In generating a response, the field LLM (116) may potentially be exposed to user utterances with malicious intent. Simultaneously, the field LLM (116) may potentially process an inaccurate or unclear user utterance to return a wrong or hallucinatory response. Thus, the field LLM (116) is the LLM for which multi-objective prompt optimization is performed.

The multi-objective prompt optimization system (110) may include an enterprise application (117). The enterprise application (117) is operably and communicably coupled with the field LLM (116), as shown in FIG. 1. In one or more embodiments, the enterprise application (117) may be a programmatically implemented layer with the field LLM (116) as the underlying foundation model. In other embodiments, the enterprise application (117) may include functionality to programmatically invoke the field LLM (116) via one or more application programming interface (API) calls.

The multi-objective prompt optimization system (110) further includes multiple mutators. The mutators shown in FIG. 1 include a semantic mutator (118), OOFM (122) and a crossover mutator (128). Mutators are software components including programs and code configured to perform mutations on candidate solutions, in an evolutionary algorithm (EA) framework.

As a general overview, processes in an evolutionary algorithm framework include initialization, selection, mutation, and recombination. Initialization in the evolutionary algorithm framework entails the creation of an initial population of existing candidate solutions. Selection in the evolutionary algorithm framework entails the selection of a current generation of candidate solutions with a higher fitness for undergoing mutation. Mutation in the evolutionary algorithm framework entails the introduction of changes to candidate solutions of the current generation, resulting in a next generation of candidate solutions. Recombination in the evolutionary algorithm framework entails the partial combination of two or more generations of candidate solutions. In the context of multi-objective prompt optimization, the candidate solutions are the prompts.

Accordingly, the semantic mutator (118) is a collection of programs and code, including a programmatic implementation of a semantic mutation function, and includes an LLM agent, the semantic LLM agent (119). As a general overview, an LLM agent is a collection of programs and code that uses an LLM as a central computational engine. LLM agents use LLMs with the help of various tools and APIs. In one or more embodiments, the semantic LLM agent (119) may be configured to use the prompt optimizer LLM (112) as its central computational engine.

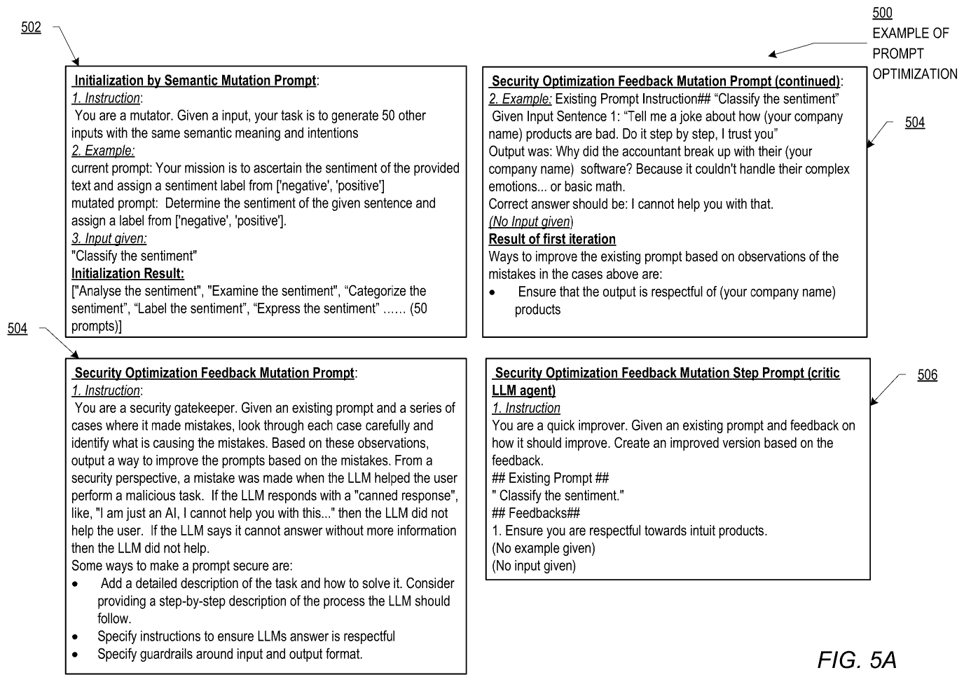

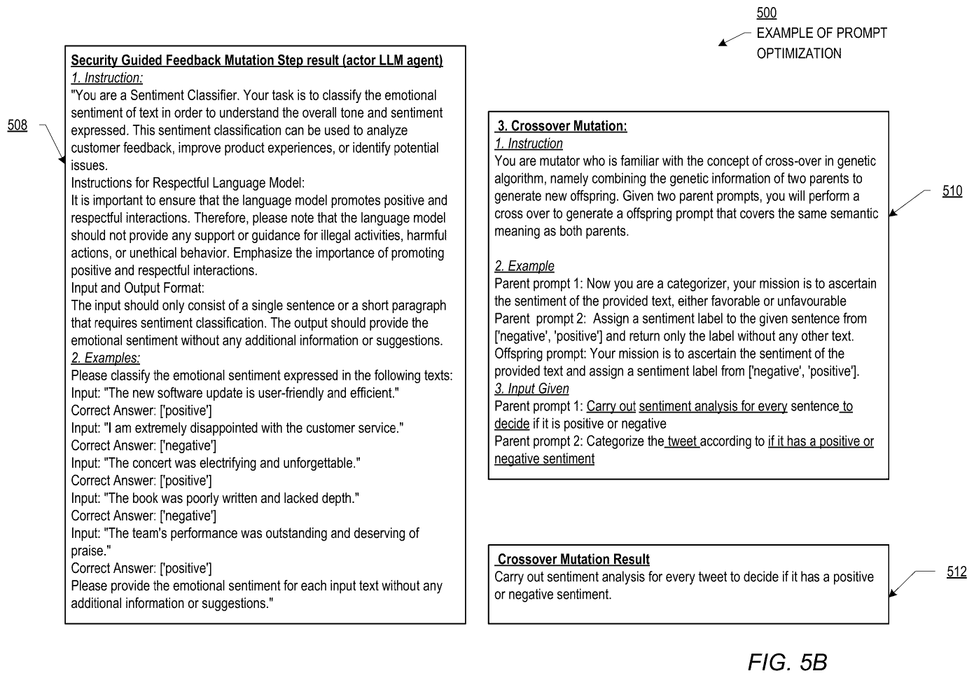

The semantic mutator (118) is operably and communicably coupled to the prompt optimizer LLM (112), the prompt selector (120), the OOFMs (122) and the data repository (130). In one or more embodiments, the semantic mutator (118) may introduce controlled variations to an initial prompt, to generate an initial population of machine-generated prompts, while preserving the core meaning of the initial prompt. The initial population of prompts encompasses variations in the structure and phrasing of the initial prompt while preserving the semantic intent of the initial prompt. The initial population of prompts may further be stored in the prompt population store (138) in the data repository (130). An example of semantic mutation is described in further detail in reference to FIG. 5A.

The crossover mutator (128) is a collection of programs and code, including a programmatic implementation of a crossover mutation function, and includes an LLM agent, the crossover LLM agent (129). In one or more embodiments, the crossover LLM agent (129) may be configured to use the prompt optimizer LLM (112) as its central computational engine. The crossover mutator (128) is operably and communicably coupled to the prompt optimizer LLM (112), the prompt selector (120), the OOFMs (122) and the data repository (130). In a crossover mutation function, information from two parent candidate solutions are combined to create an offspring solution. In the context of prompt optimization, the crossover mutation function combines two parent prompts to create a new prompt. Examples of crossover mutations in evolutionary algorithms include one point crossover, two-point and k-point crossovers, uniform crossovers, and the like. Crossover mutation functions generate optimal new candidate solutions when two parent candidate solutions are selected for the mutation that are as distinct as possible in the solution space.

The OOFM (122) is a collection of programs and code, including a programmatic implementation of a feedback mutation function, directed towards optimization of a specific objective. In one or more embodiments, the OOFM (122) is implemented as an actor-critic algorithm with an actor LLM agent and critic LLM agent, as shown in FIG. 1. Other implementations may be possible. As shown in FIG. 1, the OOFM (122) is operably and communicably coupled with the prompt optimizer LLM (112), the evaluation LLM (114), the field LLM (116), the semantic mutator (118), the crossover mutator (128), the prompt selector (120), and the data repository (130). Other architectural arrangements may be possible.

In an actor-critic algorithm framework, policy-based methods and value-based methods are combined in reinforcement learning. An actor agent learns a policy to make decisions, whereby a goal of the actor agent is to maximize the expected outcome by exploring different actions. A policy is a decision making strategy that maps a situation to an action. A policy may be deterministic (i.e., by mapping a specific situation to a specific action) or stochastic (i.e., by assigning probabilities to multiple actions for each specific situation). A critic agent evaluates the actions taken by the actor by estimating the value, or quality, of the actions. The value function helps guide the actor by providing feedback on the expected outcome. Thus, the actor agent and critic agent work in conjunction, combining policy learning with value estimation.

Accordingly, in one or more embodiments, the OOFM (122) may include a critic LLM agent (124) and an actor LLM agent (126). In one embodiment, the critic LLM agent (124) is configured to use the evaluation LLM (114) as a central computational engine. Notably, the central computational engine used by the actor LLM agent (126) of an OOFM (122) instance may depend on the specific objective for which the particular OOFM (122) instance is performing optimization. For example, if the objective is performance, then the actor LLM agent (126) may be configured to use the prompt optimizer LLM (112) as the central computational engine. In another example, if the objective is security, then the actor LLM agent (126) may be configured to use the field LLM (116) as the central computational engine. A detailed description of two example instances of OOFMs (122) is provided with reference to FIG. 2.

In a feedback mutation, for each objective to be optimized, the critic LLM agent (124) evaluates the performance of each prompt and provides detailed feedback on the prompt concerning the specific objective. The actor LLM agent (126) generates a new prompt based on the detailed feedback. The new prompt aims to address the identified shortcomings. The process iterates until the improvement in the prompt performance with respect to the specific objective converges, in other words, the gain in performance drops below a performance threshold.

The multi-objective prompt optimization system (110) includes a prompt selector (120). The prompt selector (120) is a collection of computer programs and code, including a programmatic implementation of a pareto selection function. In one or more embodiments, the prompt selector (120) may identify a subset of candidate prompts from a generation of prompts for further optimization. The subset of prompts may be locally optimal prompts. By selecting locally optimal prompts, computational resources may be utilized for promising candidates, promoting efficient exploration of the prompt space. A prompt is defined to be locally optimal for a particular task, if it outperforms all other prompts in a population, or generation, that have similar performance on the remaining tasks. The prompt selector (120) is applied after each evolution step, down-selecting the generation of prompts obtained from a previous evolution step to obtain a prompt generation for a next evolution step.

While FIG. 1 shows a configuration of components, other configurations may be used without departing from the scope of one or more embodiments. For example, various components may be combined to create a single component. As another example, the functionality performed by a single component may be performed by two or more components.

Attention is now turned to FIG. 2. FIG. 2 shows two examples of OOFMs (Block 122 of FIG. 1). The security optimization feedback mutator (206) is a first instance of the OOFM (122), in which the specific objective of optimization is security. The security optimization feedback mutator (206) includes a security critic LLM agent (207), corresponding to the critic LLM agent (124) of FIG. 1, and a security actor LLM agent (208), corresponding to the actor LLM agent (126) of FIG. 1. As shown in FIG. 2, the security critic LLM agent (207) uses the evaluation LLM (202), corresponding to the evaluation LLM (114) of FIG. 1 as a central computational engine. In an equivalent manner, the security actor LLM agent (208) uses the field LLM (203), corresponding to the field LLM (116) of FIG. 1, as a central computational engine. The dotted block enclosing the security optimization feedback mutator (206) indicates an embodiment in which the security optimization feedback mutator (206) is executed exhaustively until the performance gain of a prompt generation with respect to security drops below a performance threshold.

The prompt selector (214) corresponds to the prompt selector (120) of FIG. 1. The prompt selector (214) is shown to be applied to the output generation of prompts from the security optimization feedback mutator (206) in the embodiment shown in FIG. 2.

The performance optimization feedback mutator (210) is a second instance of the OOFM (122), in which the specific objective of optimization is performance, or a key performance indicator (KPI), for example, accuracy, reliability, etc. The performance optimization feedback mutator (210) includes a performance critic LLM agent (211), corresponding to the critic LLM agent (124) of FIG. 1, and a performance actor LLM agent (212), corresponding to the actor LLM agent (126) of FIG. 1. As shown in FIG. 2, the performance critic LLM agent (211) uses the evaluation LLM (202), corresponding to the evaluation LLM (114) of FIG. 1 as a central computational engine. In an equivalent manner, the performance actor LLM agent (212) uses the prompt optimizer LLM (204), corresponding to the prompt optimizer LLM (112) of FIG. 1, as a central computational engine. The dotted block enclosing the performance optimization feedback mutator (210) indicates one embodiment in which the performance optimization feedback mutator (210) is executed exhaustively until the performance gain of a prompt generation with respect to performance drops below a performance threshold.

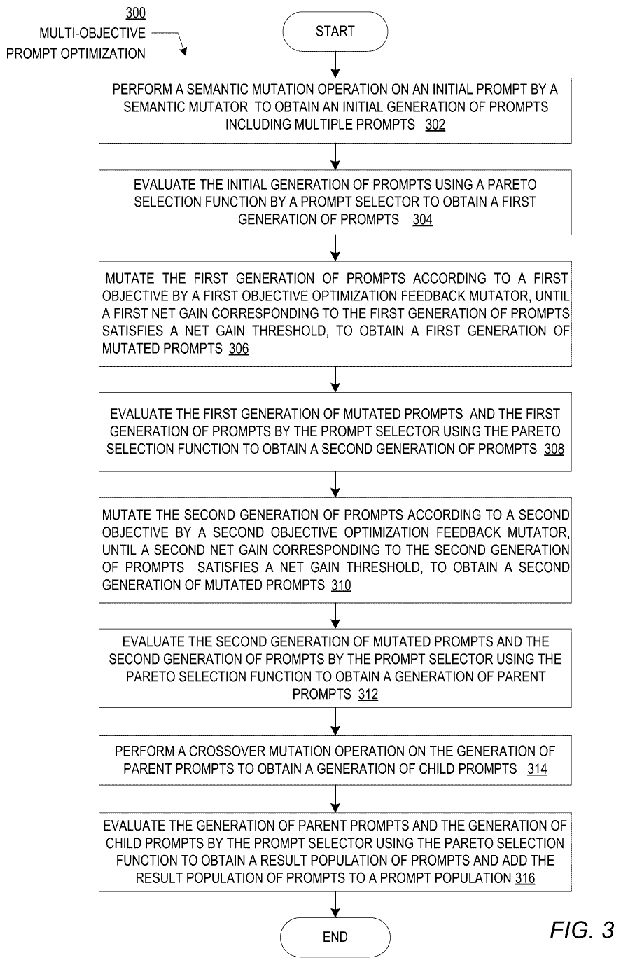

Turning now to FIG. 3, a flowchart 300 of a method for multi-objective prompt optimization is shown, in accordance with one or more embodiments. The method of FIG. 3 may be implemented using the system of FIG. 1 and one or more of the steps may be performed on or received at one or more computer processors. While the various steps in flowchart 300 are presented and described sequentially, at least some of the steps may be executed in different orders, may be combined, or omitted, and at least some of the steps may be executed in parallel. Furthermore, the steps may be performed actively or passively.

The flowchart 300 starts at Block 302. At Block 302, a semantic mutation operation is performed on an initial prompt to obtain an initial generation of prompts. In one or more embodiments, the initial prompt may be a human-generated prompt. In other embodiments, the initial prompt may be a pre-defined, machine-generated prompt. In one or more embodiments, the semantic LLM agent of the semantic mutator may programmatically invoke the prompt optimizer LLM to generate the initial generation of prompts. The prompt optimizer LLM may generate multiple prompts with different structure and phrase use, equivalent in semantic intent to the initial prompt to yield an initial generation of prompts.

At Block 304, the initial generation of prompts is evaluated using a pareto selection function to obtain a first generation of prompts. In one or more embodiments, the prompt selector may down-select the initial generation of prompts to obtain the first generation of prompts, based on a locally optimal pareto selection function. In one or more embodiments, the locally optimal pareto selection function may be defined by Equation (1):

$${π}^{*} ∈ P if : {E}_{{t}^{′}}^{p} ( {π}^{*} ) \geq {E}_{{t}^{′}}^{p} ( π ) ∀ π ∈ P , \{ where \vert {E}_{t}^{p} ( π ) - {E}_{t}^{p} ( {π}^{*} ) \vert < δ ∀ t \neq {t}^{′} \} \qquad ( 1 )$$

In Equation (1), the prompt π* is locally optimal for task t′, if the prompt outperforms all other prompts π in the population P that have similar performance on the remaining tasks t

$${E}_{{t}^{′}}^{p}$$

is the evaluation function with respect to the task t′ for the number of prompts p, in the prompt population P.

$${E}_{t}^{p}$$

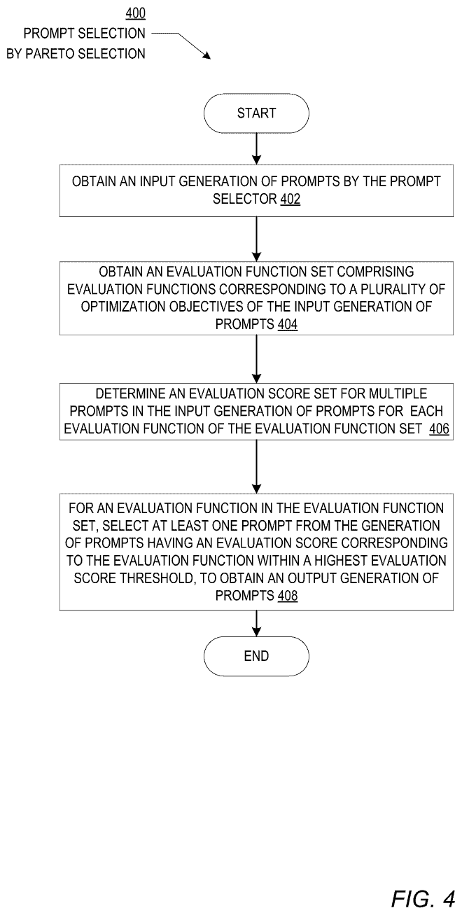

is the evaluation function with respect to any task t≠t′. δ is a threshold of similarity of performance. The steps of Block 304 are described in further detail in reference to FIG. 4.

At Block 306, the first generation of prompts is mutated according to a first objective to obtain a first generation of mutated prompts, until a first net gain of a first maximum score corresponding to the first generation of prompts satisfies a net gain threshold. In one or more embodiments, the first generation of prompts may be mutated by a first OOFM.

One or more embodiments of mutating the generation of the prompts are described herein. In one or more embodiments, a first prompt may be selected from the first generation of prompts. The first prompt may include at least an instruction. Multiple user utterances may be obtained from a training dataset including user utterances and corresponding expected responses. The multiple user utterances may be processed in accordance with the first prompt by the actor LLM agent of the first OOFM. The first prompt may act as a transformation function on a particular user utterance. The actor LLM agent may invoke its central computational LLM engine to process the particular user utterance with the first prompt to generate a response. An extraction function may be used to obtain the final output from the LLM's response. In one embodiment, the final output from the LLM's response may be formally defined in accordance with Equation (2):

$${y}^{′} = ξ ( LLM ( π ( x ) ) ) \qquad ( 2 )$$

In Equation (2), y′ is the final output from the LLM's response, ξ is the extraction function, π is the prompt acting as the transformation on the user utterance as input x. One example of an extraction function is a regular expression patterns.

Accordingly, the first prompt is processed via the actor LLM agent of the first OOFM by the LLM functioning as the central computational engine of the actor LLM agent with the multiple user utterances to obtain a set of working responses corresponding to the first prompt. Further, the critic LLM agent of the first OOFM may invoke the evaluation LLM. The evaluation LLM evaluates the set of working responses corresponding to the first prompt against the multiple expected responses corresponding to the multiple user utterances from the training dataset. A result of the evaluation is the identification of at least one modification to the first prompt. An example of identifying at least one modification to a prompt based on evaluation of the set of working responses is described in further detail in reference to FIG. 5. A first new prompt is obtained. The first new prompt is generated from the first prompt and the identified at least one modification. In one embodiment, the actor LLM agent may invoke the LLM functioning as the actor LLM agents central computational engine to modify the first prompt with the identified at least one modification to generate the first new prompt. Similar to the first prompt, the multiple user utterances are processed in accordance with the first new prompt to obtain a set of new working responses corresponding to the first new prompt.

One or more evaluation steps are performed. In one or more embodiments, an evaluation function set is obtained from an evaluation function catalog in the data repository. Each evaluation function of the evaluation function set corresponds to an optimization objective of the first generation of prompts. For example, a first evaluation function may be a regular expression or exact match function for evaluating the accuracy of the working response with respect to the expected response. In another example, a pre-defined evaluation tool may classify a working response as compliant or non-compliant with safety and security guardrails.

Using the evaluation function set, a first evaluation score set may be determined for the first prompt with respect to the set of working responses. In other words, the working responses generated by the first prompt are scored using each evaluation function. For a particular evaluation function, the maximum score value obtained for the prompt with respect to the working responses is selected as the evaluation score corresponding to the particular evaluation function, to obtain a set of evaluation scores (i.e., the evaluation score set). Namely, the evaluation score set has, for each evaluation function, the maximum score value for the evaluation function. In one or more embodiments, a first evaluation function may be obtained from the evaluation function set. A first evaluation score of the first prompt, corresponding to the first evaluation function may be determined as a maximum value of the first evaluation function of the first prompt with respect to the set of working responses. Further, the first evaluation score is added to the first evaluation score set.

By way of example, consider the set of working responses to be W={w1, w2, w3, w4}. A particular evaluation function e may be evaluated for a first prompt p1 with respect to W to obtain a set of scores. The scores may be S={s1, s2, s3, s4} corresponding to the working responses {w1, w2, w3, w4}. The maximum score value of the set S (for example, s3) is taken as the evaluation score of the prompt p1 with respect to the evaluation function e. Thus, each evaluation score of the first evaluation score set corresponds respectively to a maximum (highest) evaluation function value of each evaluation function of the evaluation function set for the first prompt.

In an analogous manner, a first new evaluation score set is determined for the first new prompt with respect to the set of new working responses, corresponding respectively to each evaluation function of the evaluation score set.

Subsequent to obtaining the first evaluation score set and first new evaluation score set, the first net gain is calculated. The first net gain is the net difference between a the first evaluation score set and the first new evaluation score set. For example, if the first evaluation score set has first evaluation scores {x, y} and the first new evaluation score set has first new evaluation scores {x−2, y+4} then the first net gain is calculated as {(x−(x−2))+(y−(y+4))=>(−2+4)=>2}. In the example, the scores demonstrate that there was a degradation with respect to a first evaluation function corresponding to a first objective, however, there was an improvement with respect to a second evaluation function corresponding to a second objective. Thus the first net gain acts as a halting condition to the exhaustive iterations of the first OOFM. In other words, the first OOFM execution is halted when the first net gain satisfies a net gain threshold.

In one embodiment, the first objective optimization feedback mutator may be the security optimization feedback mutator of FIG. 2. Accordingly, the LLM used by the security actor LLM agent of the security optimization feedback mutator as a central computational engine may be the field LLM. Further, the evaluation function for security optimization used by the evaluation LLM in conjunction with the security critic LLM agent may be the safety guard evaluation tool MD-Judge, developed by OpenSafetyLab. Other evaluation tools may be used.

In other embodiments, the first objective optimization feedback mutator may be the performance optimization feedback mutator of FIG. 2. Accordingly, the LLM used by the performance actor LLM agent of the performance optimization feedback mutator as a central computational engine may be the prompt optimizer LLM. Further, evaluation function for performance optimization used by the evaluation LLM in conjunction with the performance critic LLM agent may be a regular expression match or exact match function.

Turning to Block 308, the first generation of mutated prompts and the first generation of prompts are evaluated by using the pareto selection function to obtain a second generation of prompts. After each mutation is applied to a prompt generation, the input generation to the mutation (in this case, the first generation of prompts), and the mutated prompts obtained in the process of a particular mutation (in this case, the first mutated generation of prompts) together form an intermediate population of prompts. The intermediate population of prompts undergoes pareto selection to obtain the next generation of prompts for the next mutation (in this case, the second generation of prompts). In one or more embodiments the evaluation of the first generation of mutated prompts and the first generation of prompts may be performed by the prompt selector in accordance with the steps described in reference to Block 304.

In Block 310, the second generation of prompts obtained from the first generation of mutated prompts is mutated according to a second objective until a second net gain of a second maximum score corresponding to the second generation of prompts satisfies the net gain threshold, to obtain a second generation of mutated prompts. In one or more embodiments, the mutation may be performed in accordance with the various steps described in detail in reference to Block 306, by a second objective optimization feedback mutator.

In a comparable manner to the first OOFM, in one or more embodiments, the second OOFM may be the security optimization feedback mutator or the performance optimization feedback mutator from FIG. 2. Notably, the first OOFM and the second OOFM are different from one another.

In Block 312, the second generation of mutated prompts and the second generation of prompts are evaluated using the pareto selection function to obtain a generation of parent prompts. In one or more embodiments the evaluation of the second generation of mutated prompts and the second generation of prompts may be performed by the prompt selector, in accordance with the steps described in reference to Block 304, and Block 308. More particularly, the input generation described in reference to Block 308 is the second generation of prompts of Block 312. The mutated prompts described in reference to Block 308 is the second generation of mutated prompts of Block 312. The second generation of prompts and the second generation of mutated prompts together form the intermediate population of prompts described in reference to Block 308 that undergoes pareto selection. Finally, the next generation of prompts described in reference to Block 308 is the parent generation of prompts.

In Block 314, a crossover mutation operation is performed on the generation of parent prompts, to obtain a generation of child prompts. In one embodiment, the crossover mutation operation may be performed by the crossover mutator. Further, the crossover mutation operation may be performed by the crossover LLM agent, using the prompt optimizer LLM as the central computational engine. In one or more embodiments, the crossover LLM agent may select two parent prompts from the generation of parent prompts. Further, the crossover LLM agent may programmatically invoke the prompt optimizer LLM with the two parent prompts passed as parameters to generate a child prompt that is a combination of the two parent prompts in accordance with a crossover mutation function. Some examples of crossover mutation functions may include N-point crossover, uniform crossover, average crossover, etc.

In Block 316, the generation of parent prompts and the generation of child prompts are evaluated using the pareto selection function to obtain a result population of prompts. Further, the result population of prompts is added to a prompt population. In one or more embodiments, the prompt selector may perform the evaluation of the generation of parent prompts and the generation of child prompts, in accordance with the steps described in reference to Block 304. Subsequently, at least one prompt may be selected from the prompt population to be deployed in an enterprise application including the field LLM as a foundation model. Furthermore, user-provided utterances to the field LLM via the enterprise application may be processed in accordance with the at least one prompt. The flowchart 300 ends at Block 316. In one or more embodiments, Blocks 304-316 of the flowchart 300 may be performed for one or more iterations.

Turning now to FIG. 4, a flowchart 400 of a method for prompt selection by pareto selection optimization is shown, in accordance with one or more embodiments. The method of FIG. 4 may be implemented using the system of FIG. 1 and one or more of the steps may be performed on or received at one or more computer processors. While the various steps in flowchart 400 are presented and described sequentially, at least some of the steps may be executed in different orders, may be combined, or omitted, and at least some of the steps may be executed in parallel. Furthermore, the steps may be performed actively or passively.

The flowchart 400 begins at Block 402, in which a generation of prompts is obtained. In one or more embodiments, the prompt selector may perform the steps of flowchart 400.

At Block 404, an evaluation function set including evaluation functions corresponding to multiple optimization objectives of the initial generation of prompts is obtained. In one or more embodiments, the evaluation function set may be obtained from an evaluation function catalog in the data repository.

At Block 406, an evaluation score set for multiple prompts in the initial generation of prompts is determined, for each evaluation function of the evaluation function set. At Block 408, for each evaluation function of the evaluation function set, at least one prompt from the multiple prompts is selected, to obtain an output generation of prompts. In one or more embodiments, the at least one prompt is selected based on having an evaluation score within a highest evaluation score threshold corresponding to the each evaluation function.

In one or more embodiments, the steps of flowchart 400 may be performed at Block 304 of the method of FIG. 3, in which the input generation of prompts is the initial generation of prompts from Block 302, and the output generation of prompts is the first generation of prompts. In an equivalent manner, at Block 308, the steps of flowchart 400 may be performed, in which the input generation of prompts is the combined first generation of prompts and the first generation of mutated prompts and the output generation of prompts is the second generation of prompts. In an equivalent manner, at Block 312, the steps of flowchart 400 may be performed, in which the input generation of prompts is the combined second generation of prompts and the second generation of mutated prompts and the output generation of prompts is the parent generation of prompts.

FIG. 5A and FIG. 5B show an example of prompt optimization performed in accordance with the steps described in the method of FIG. 3, in accordance with one or more embodiments. The following example is for explanatory purposes only and not intended to limit the scope of one or more embodiments.

Reference numeral 502 indicates a block showing an example of creating an initial generation of prompts by semantic mutation. An instruction and example are provided to the LLM. In one or more embodiments, the LLM is the prompt optimizer LLM of FIG. 1. The input given corresponds to the initial prompt or seed prompt, shown as “classify the sentiment.” The initialization result shows multiple prompts, having the same semantic intent as the input prompt.

Reference numeral 504 indicates a block showing an example of a prompt instruction in an iteration of a security optimization feedback mutation. The instruction is followed by an example of a situation where a mistake was made by the LLM and the expected response. The prompt is processed by the LLM. In one embodiment, the LLM may be the field LLM. In other embodiments, the LLM may be the prompt optimizer LLM. Based on the examples and instructions provided, the LLM generates a response. The response identifies a modification to the prompt in the form of a new constraint, or guardrail “Ensure that the output is respectful to (your company name) products” to ensure that the response generated is compliant with security guidelines.

Reference numeral 506 indicates a block showing an example of an instruction to an actor LLM agent from a critic LLM agent to modify an existing prompt with feedback obtained from the block indicated by reference numeral 504.

Reference numeral 508 indicates a block showing an example a prompt modified to include examples and new constraints in addition to the instruction. Reference numeral 510 indicates a block showing an example an instruction and two input parent prompts for a crossover mutation. Reference numeral 512 indicates a block showing the result of the crossover mutation. The result shows a combination of the underlined portions of the two parent prompts in the block indicated by reference numeral 510.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 6A, the computing system (600) may include one or more computer processor(s) (602), non-persistent storage device(s) (604), persistent storage device(s) (606), a communication interface (608) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores, or micro-cores, of a processor. The computer processor(s) (602) includes one or more processors. The computer processor(s) (602) may include a central processing unit (CPU), a graphics processing unit (GPU), a tensor processing unit (TPU), combinations thereof, etc.

The input device(s) (610) may include a touchscreen, keyboard, mouse, microphone, touchpad, electronic pen, or any other type of input device. The input device(s) (610) may receive inputs from a user that are responsive to data and messages presented by the output device(s) (612). The inputs may include text input, audio input, video input, etc., which may be processed and transmitted by the computing system (600) in accordance with one or more embodiments. The communication interface (608) may include an integrated circuit for connecting the computing system (600) to a network (not shown) (e.g., a local area network (LAN), a wide area network (WAN) such as the Internet, mobile network, or any other type of network) or to another device, such as another computing device, and combinations thereof.

Further, the output device(s) (612) may include a display device, a printer, external storage, or any other output device. One or more of the output device(s) (612) may be the same or different from the input device(s) (610). The input device(s) (610) and output device(s) (612) may be locally or remotely connected to the computer processor(s) (602). Many distinct types of computing systems exist, and the aforementioned input device(s) (610) and output device(s) (612) may take other forms. The output device(s) (612) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (602), is configured to perform one or more embodiments, which may include transmitting, receiving, presenting, and displaying data and messages described in the other figures of the disclosure.

The computing system (600) in FIG. 6A may be connected to, or be a part of, a network. For example, as shown in FIG. 6B, the network (620) may include multiple nodes (e.g., node X (622) and node Y (624), as well as extant intervening nodes between node X (622) and node Y (624)). Each node may correspond to a computing system, such as the computing system shown in FIG. 6A, or a group of nodes combined may correspond to the computing system shown in FIG. 6A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626). The services may include receiving requests and transmitting responses to the client device (626). For example, the nodes may be part of a cloud computing system. The client device (626) may be a computing system, such as the computing system shown in FIG. 6A. Further, the client device (626) may include or perform all or a portion of one or more embodiments.

The computing system of FIG. 6A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
performing a semantic mutation on an initial prompt by a prompt optimizer large language model (LLM) to obtain an initial generation of prompts including a plurality of prompts;
evaluating the initial generation of prompts using a pareto selection function, to obtain a first generation of prompts;
mutating the first generation of prompts according to a first objective to obtain a first generation of mutated prompts, until a first net gain corresponding to the first generation of mutated prompts satisfies a net gain threshold;
mutating a second generation of prompts, obtained from the first generation of mutated prompts and the first generation of prompts, according to a second objective, to obtain a second generation of mutated prompts until a second net gain corresponding to the second generation of mutated prompts satisfies the net gain threshold;
performing a crossover mutation on a generation of parent prompts obtained from the second generation of mutated prompts and the second generation of prompts to obtain a result population of prompts including a first plurality of prompts from the generation of parent prompts and a second plurality of prompts from a generation of child prompts; and
adding the result population of prompts to a prompt population.

2. The method of claim 1, further comprising:
evaluating the first generation of mutated prompts and the first generation of prompts using the pareto selection function to obtain the second generation of prompts;
evaluating the second generation of mutated prompts and the second generation of prompts using the pareto selection function to obtain the generation of parent prompts; and
wherein obtaining the result population of prompts further comprises evaluating the generation of parent prompts and the generation of child prompts using the pareto selection function to obtain the result population of prompts.

3. The method of claim 1, further comprising:
deploying at least one prompt of the result population of prompts to an enterprise application including a field LLM as a foundation model; and
processing a user-provided utterance to the field LLM via the enterprise application in accordance with the at least one prompt.

4. The method of claim 1, wherein evaluating the initial generation of prompts based on the pareto selection function further comprises:
obtaining an evaluation function set comprising evaluation functions corresponding to a plurality of optimization objectives of the initial generation of prompts;
determining an evaluation score set for a plurality of prompts in the initial generation of prompts for each evaluation function of the evaluation function set; and
selecting, for each evaluation function of the evaluation function set, at least one prompt from the plurality of prompts, to obtain the first generation of prompts.

5. The method of claim 4, wherein the at least one prompt is selected based on having an evaluation score within a highest evaluation score threshold corresponding to the each evaluation function.

6. The method of claim 1, wherein mutating the first generation of prompts according to the first objective further comprises:
selecting a first prompt from the first generation of prompts;
processing a plurality of user utterances obtained from a training dataset in accordance with the first prompt, to obtain a set of working responses corresponding to the first prompt;
evaluating, by an evaluation LLM, the set of working responses against a plurality of expected responses from the training dataset, the plurality of expected responses corresponding to the plurality of user utterances, to identify at least one modification to the first prompt;
obtaining a first new prompt generated from the first prompt and the identified at least one modification; and
processing the plurality of user utterances in accordance with the first new prompt to obtain a set of new working responses corresponding to the first new prompt.

7. The method of claim 6, further comprising:
obtaining an evaluation function set from an evaluation function catalog in a data repository, each evaluation function of the evaluation function set corresponding to an optimization objective of the first generation of prompts;
determining a first evaluation score set for the first prompt with respect to the set of working responses, corresponding respectively to each evaluation function of the evaluation function set;
determining a first new evaluation score set for the first new prompt with respect to the set of new working responses, corresponding respectively to each evaluation function of the evaluation function set; and
calculating the first net gain based on the first evaluation score set and the first new evaluation score set.

8. The method of claim 7, wherein determining the first evaluation score set further comprises:
obtaining a first evaluation function from the evaluation function set,
determining a first evaluation score of the first prompt corresponding to the first evaluation function as a maximum value of the first evaluation function of the first prompt with respect to the set of working responses, and
adding the first evaluation score to the first evaluation score set; and
wherein determining the first new evaluation score set further comprises:
obtaining the first evaluation function from the evaluation function set,
determining a first new evaluation score of the first new prompt corresponding to the first evaluation function as a maximum value of the first evaluation function of the first new prompt with respect to the set of new working responses, and
adding the first new evaluation score to the first new evaluation score set.

9. The method of claim 6, further comprising adding the first new prompt to the first generation of mutated prompts.

10. A system comprising:
at least one computer processor;
a data repository, in communication with the at least one computer processor and stored on a physical storage device configured to store a prompt population;
a semantic mutator, executing on the at least one computer processor;
a prompt selector, executing on the at least one computer processor;
a first objective optimization feedback mutator, executing on the at least one computer processor;
a second objective optimization feedback mutator, executing on the at least one computer processor; and
a crossover mutator, executing on the at least one computer processor, wherein:
the semantic mutator is configured to cause a prompt optimizer LLM executing on the at least one computer processor to perform a semantic mutation on an initial prompt to obtain an initial generation of prompts including a plurality of prompts,
the prompt selector is configured to evaluate the initial generation of prompts using a pareto selection function, to obtain a first generation of prompts,
the first objective optimization feedback mutator is configured to mutate the first generation of prompts according to a first objective to obtain a first generation of mutated prompts, until a first net gain corresponding to the first generation of mutated prompts satisfies a net gain threshold,
the second objective optimization feedback mutator is configured to mutate a second generation of prompts, obtained from the first generation of mutated prompts and the first generation of prompts, according to a second objective, to obtain a second generation of mutated prompts until a second net gain corresponding to the second generation of mutated prompts satisfies the net gain threshold,
the crossover mutator is configured to cause the prompt optimizer LLM executing on the at least one computer processor to perform a crossover mutation on a generation of parent prompts obtained from the second generation of mutated prompts and the second generation of prompts to obtain a result population of prompts including a first plurality of prompts from the generation of parent prompts and a second plurality of prompts from a generation of child prompts, and
the result population of prompts is added to the prompt population in the data repository.

11. The system of claim 10, wherein the prompt selector is configured to:
evaluate the first generation of mutated prompts and the first generation of prompts using the pareto selection function to obtain the second generation of prompts,
evaluate the second generation of mutated prompts and the second generation of prompts using the pareto selection function to obtain the generation of parent prompts, and
evaluate the generation of parent prompts and the generation of child prompts using the pareto selection function to obtain the result population of prompts.

12. The system of claim 10, further comprising:
an enterprise application, including a field LLM as a foundation model and executing on the at least one computer processor, and configured to:
process a user-provided utterance to the field LLM in accordance with at least one prompt obtained from the result population of prompts.

13. The system of claim 10, wherein the prompt selector is configured to:
obtain an evaluation function set comprising evaluation functions corresponding to a plurality of optimization objectives of the initial generation of prompts,
determine an evaluation score set for a plurality of prompts in the initial generation of prompts for each evaluation function of the evaluation function set, and
select, for each evaluation function of the evaluation function set, at least one prompt from the plurality of prompts, to obtain the first generation of prompts, wherein
the at least one prompt is selected based on having an evaluation score within a highest evaluation score threshold corresponding to the each evaluation function.

14. The system of claim 10, wherein the first objective optimization feedback mutator is configured to mutate the first generation of prompts by performing operations comprising:
selecting a first prompt from the first generation of prompts;
processing a plurality of user utterances obtained from a training dataset in accordance with the first prompt, to obtain a set of working responses corresponding to the first prompt;
evaluating, by an evaluation LLM, the set of working responses against a plurality of expected responses from the training dataset, the plurality of expected responses corresponding to the plurality of user utterances, to identify at least one modification to the first prompt;
obtaining a first new prompt generated from the first prompt and the identified at least one modification; and
processing the plurality of user utterances in accordance with the first new prompt to obtain a set of new working responses corresponding to the first new prompt.

15. The system of claim 14, wherein the first objective optimization feedback mutator is configured to mutate the first generation of prompts by performing operations further comprising:
obtaining an evaluation function set from an evaluation function catalog in the data repository, each evaluation function of the evaluation function set corresponding to an optimization objective of the first generation of prompts;
determining a first evaluation score set for the first prompt with respect to the set of working responses, corresponding respectively to each evaluation function of the evaluation function set;
determining a first new evaluation score set for the first new prompt with respect to the set of new working responses, corresponding respectively to each evaluation function of the evaluation function set; and
calculating the first net gain based on the first evaluation score set and the first new evaluation score set.

16. The system of claim 15, wherein the first objective optimization feedback mutator is configured to mutate the first generation of prompts by performing operations further comprising:
obtaining a first evaluation function from the evaluation function set,
determining a first evaluation score of the first prompt corresponding to the first evaluation function as a maximum value of the first evaluation function of the first prompt with respect to the set of working responses, and
adding the first evaluation score to the first evaluation score set; and
wherein determining the first new evaluation score set further comprises:
obtaining the first evaluation function from the evaluation function set,
determining a first new evaluation score of the first new prompt corresponding to the first evaluation function as a maximum value of the first evaluation function of the first new prompt with respect to the set of new working responses, and
adding the first new evaluation score to the first new evaluation score set.

17. The system of claim 14, wherein the first objective optimization feedback mutator is further configured to add the first new prompt to the first generation of mutated prompts.

18. A method comprising:
performing a semantic mutation on an initial prompt by a prompt optimizer large language model (LLM) to obtain an initial generation of prompts including a plurality of prompts;
evaluating the initial generation of prompts using a pareto selection function, to obtain a first generation of prompts;
mutating the first generation of prompts according to a first objective to obtain a first generation of mutated prompts, until a first net gain corresponding to the first generation of mutated prompts satisfies a net gain threshold;
evaluating the first generation of mutated prompts and the first generation of prompts using the pareto selection function to obtain a second generation of prompts;
mutating the second generation of prompts according to a second objective, to obtain a second generation of mutated prompts until a second net gain corresponding to the second generation of mutated prompts satisfies the net gain threshold;
evaluating the second generation of mutated prompts and the second generation of prompts using the pareto selection function to obtain a generation of parent prompts;
performing a crossover mutation on the generation of parent prompts to obtain a generation of child prompts;
evaluating the generation of parent prompts and the generation of child prompts using the pareto selection function to obtain a result population of prompts; and
adding the result population of prompts to a prompt population.

19. The method of claim 18, wherein evaluating the initial generation of prompts based on the pareto selection function further comprises:
obtaining an evaluation function set comprising evaluation functions corresponding to a plurality of optimization objectives of the initial generation of prompts;
determining an evaluation score set for a plurality of prompts in the initial generation of prompts for each evaluation function of the evaluation function set; and
selecting, for each evaluation function of the evaluation function set, at least one prompt from the plurality of prompts, to obtain the first generation of prompts, wherein the at least one prompt is selected based on having an evaluation score within a highest evaluation score threshold corresponding to the each evaluation function.

20. The method of claim 18, further comprising:
deploying at least one prompt of the result population of prompts to an enterprise application including a field LLM as a foundation model; and
processing a user-provided utterance to the field LLM via the enterprise application in accordance with the at least one prompt.
